(19) United States
(12) Patent Application Publication
(10) Pub. No.: US 2026/0308067 A1
(43) Pub. Date: Oct. 8, 2026

(54) DIELECTRIC COMPOSITION WITH HIGH-TEMPERATURE STABILITY

(71) Applicant: AMOTECH CO., LTD., Incheon (KR)

(72) Inventors: Soomin OH, Incheon (KR); Haeyoung JIN, Incheon (KR); Junsuh YU, Incheon (KR); Kyuhwan PARK, Incheon (KR); Seongun MA, Incheon (KR); Tonggi KIM, Incheon (KR); Byoungchul RHO, Incheon (KR); Sumin YANG, Incheon (KR)

(73) Assignee: AMOTECH CO., LTD., Incheon (KR)

(21) Appl. No.: 19/478,078

(22) PCT Filed: Apr. 18, 2024
(86) PCT No.: PCT/KR2024/005201

§ 371 Date: Oct. 23, 2025

(30) Foreign Application Priority Data
Apr. 24, 2023 (KR) 10-2023-0053134

(51) Int. Cl. C04B 35/468; H01G 4/12

(52) U.S. Cl. CPC C04B 35/468; H01G 4/1227; C04B 2235/3206; C04B 2235/3215; C04B 2235/3225; C04B 2235/3227; C04B 2235/3234; C04B 2235/3284; C04B 2235/3454

(57) ABSTRACT

A dielectric composition comprising a barium titanate-based base material major component and a minor component is disclosed. The dielectric composition comprises at least one minor component from among: a first minor component, which can be oxides or carbonates of Yb; a second minor component, which can be oxides including Ba and Zr; a third minor component, which can be oxides or carbonates of Y; a fourth minor component, which can be oxides or carbonates of Mg; a fifth minor component, which can be oxides or carbonates of V and Mn; and a sixth minor component, which can be oxides or carbonates of Si, wherein the at least one minor component can comprise the first minor component. The present invention satisfies X8R properties specified by EIA standards.

### TECHNICAL FIELD

The present disclosure relates to a dielectric composition with high-temperature stability, and more particularly, to a dielectric composition that satisfies X8R characteristics.

### BACKGROUND ART

Multilayer ceramic chip capacitors have high capacitance and high reliability while being relatively small in size, and thus, are widely used in fields requiring precision and stability, such as automobiles and motors.

There is a demand for various factors such as capacitance, temperature stability, and voltage stability for multilayer ceramic capacitors. In particular, since multilayer ceramic capacitors used in automotive electronics operate at high temperatures, their capacitance must not change even at high temperatures. In this regard, the Electronic Industries Association (EIA) stipulates that a multilayer ceramic capacitor satisfies X8R characteristics when the capacitance change at a temperature of −55° C. to 150° C. is within ±15% of the reference capacitance at 25° C.

### DISCLOSURE

### Technical Problem

The present disclosure is to provide a dielectric composition that satisfies the X8R standard.

### Technical Solution

A dielectric composition according to embodiments of the present disclosure includes a barium titanate-based base material major component and a minor component, wherein the minor component includes at least one minor component of: a first minor component including at least one selected from the group consisting of oxides and carbonates of Yb element, a second minor component including at least one selected from the group consisting of oxides containing Ba and Zr, a third minor component including at least one selected from the group consisting of oxides and carbonates of Y element, a fourth minor component including at least one selected from the group consisting of oxides and carbonates of a fixed-valence acceptor element including Mg, a fifth minor component including at least one selected from the group consisting of oxides and carbonates of a variable-valence acceptor element including at least one of V, Mn, Cr, Fe, Ni, Co, Cu, and Zn, and a sixth minor component including at least one selected from the group consisting of oxides, carbonates, and glasses of Si element, wherein the at least one minor component includes the first minor component, and the content of the Yb element contained in the first minor component is 0.2 to 6 parts by mole per 100 parts by mole of the base material major component.

### Advantageous Effects

The dielectric composition of the present disclosure satisfies the X8R characteristics of the EIA standard.

### DESCRIPTION OF DRAWINGS

FIG. 1 is a perspective view illustrating a multilayer ceramic capacitor according to an embodiment of the present disclosure.

FIG. 2 is a perspective view illustrating a plurality of electrode units of a multilayer ceramic capacitor according to an embodiment of the present disclosure.

### MODE FOR INVENTION

Hereinafter, in order to describe in detail enough to enable those skilled in the art to easily practice the technical concept of the present disclosure, the most preferred embodiment of the present disclosure will be described with reference to the accompanying drawings. First, in adding reference numerals to the components of each drawing, it should be noted that the same components have the same numerals as much as possible, even if they are shown in different drawings. In addition, in describing the present disclosure, if it is determined that a detailed description of a related known configuration or function may obscure the gist of the present disclosure, the detailed description thereof will be omitted.

The present disclosure relates to a dielectric composition. Electronic components including the dielectric composition include capacitors, inductors, piezoelectric elements, varistors, or thermistors. Hereinafter, a multilayer ceramic capacitor (MLCC) will be described as an example of the electronic components including the dielectric composition.

### Multilayer Ceramic Capacitor

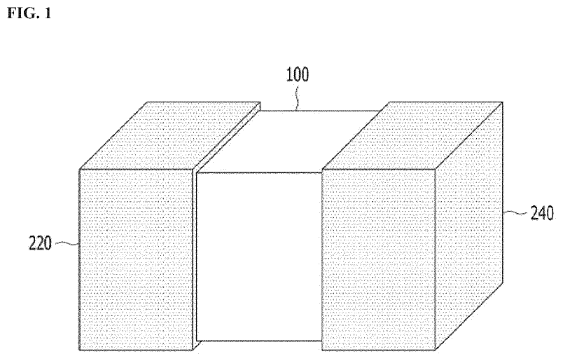

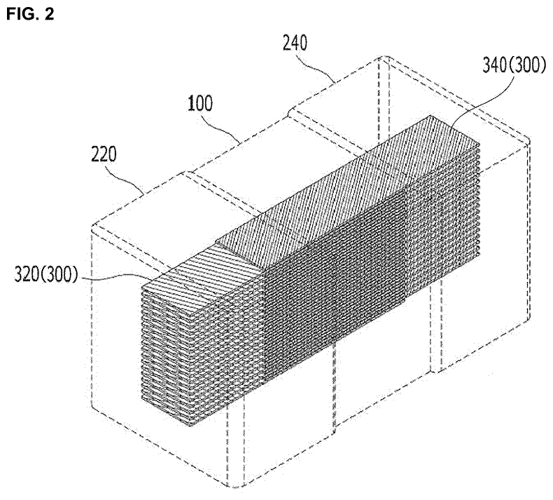

FIG. 1 is a perspective view illustrating a multilayer ceramic capacitor according to an embodiment of the present disclosure, and FIG. 2 is a perspective view illustrating a plurality of electrode units of a multilayer ceramic capacitor according to an embodiment of the present disclosure.

Referring to FIG. 1, a multilayer ceramic capacitor according to an embodiment of the present disclosure is configured to include a dielectric 100, a first external electrode 220, and a second external electrode 240.

The dielectric 100 is configured as a rectangular parallelepiped having an upper surface, a lower surface, a first side surface, a second side surface opposite to the first side surface, a third side surface, and a fourth side surface opposite to the third side surface, wherein in one example, the first side surface is the left side in the drawing, the second side surface is the right side in the drawing, the third side surface is the front side in the drawing, and the fourth side surface is the back side in the drawing.

The dielectric 100 may include a plurality of dielectric sheets. The plurality of dielectric sheets may be stacked. Each dielectric sheet may include a dielectric composition and be formed by sintering the dielectric composition.

The first external electrode 220 is an electrode disposed on the first side surface of the dielectric 100. The first external electrode 220 may be formed to extend from the first side surface of the dielectric 100 to the upper surface, lower surface, third side surface, and fourth side surface of the dielectric 100. The second external electrode 240 is an electrode disposed on the second side surface of the dielectric 100. The second external electrode 240 may be formed to extend from the second side surface of the dielectric 100 to the upper surface, lower surface, third side surface, and fourth side surface of the dielectric 100. The first external electrode 220 and the second external electrode 240 may be formed to be spaced apart from each other by a predetermined distance and face each other on the upper surface, lower surface, third side surface, and fourth side surface of the dielectric 100.

Referring to FIG. 2, the multilayer ceramic capacitor according to an embodiment of the present disclosure may further include a plurality of electrode units 300. In this case, the plurality of electrode units 300 are stacked to form a stacked body, which is disposed within the dielectric 100.

The plurality of electrode units 300 are stacked vertically in the drawing and disposed within the dielectric 100. Each electrode unit 300 includes a first electrode set 320 and a second electrode set 340, wherein the first electrode set 320 and the second electrode set 340 are alternately stacked.

The first electrode set 320 is composed of a plate-shaped conductor formed in a rectangular shape. The first electrode set 320 is disposed inside the dielectric 100 to be biased toward the first side surface of the dielectric 100. A first end of the first electrode set 320 is connected to the first external electrode 220 at the first side surface of the dielectric 100.

The second electrode set 340 is composed of a plate-shaped conductor formed in a rectangular shape. The second electrode set 340 is disposed inside the dielectric 100 to be biased toward the second side surface of the dielectric 100. A first end of the second electrode set 340 is connected to the second external electrode 240 at the second side surface of the dielectric 100.

The first electrode set 320 and the second electrode set 340 are respectively disposed to be distributed on two adjacent dielectric sheets among the dielectric sheets included in the dielectric 100. The first electrode set 320 and the second electrode set 340 may partially overlap each other with the dielectric sheet 110 interposed therebetween.

### Dielectric Composition and Manufacturing Method Thereof

Hereinafter, a dielectric composition and a manufacturing method thereof according to embodiments of the present disclosure will be described in detail. The dielectric composition can form the dielectric 100 described above. However, in order to avoid redundant description, any content that overlaps with the above description will be omitted.

The dielectric composition according to embodiments of the present disclosure may include a base material major component including a rare earth element. The base material major component is a barium titanate-based compound including Ba and Ti, preferably BaTiO₃. Furthermore, the dielectric composition according to embodiments of the present disclosure may further include minor components, which may include first to sixth minor components.

The dielectric composition according to embodiments of the present disclosure in may include minor components shown in Table 1 per 100 moles of the base material BaTiO₃.

TABLE 1

| First minor | Second minor | Third minor | Fourth minor | Fifth minor | | Sixth minor |
|---|---|---|---|---|---|---|
| component | component | component | component | component | | component |
| Yb₂O₃ | BaZrO₃ | Y₂O₃ | MgCO₃ | V₂O₅ | MnO₂ | Ba_{0.6}Ca_{0.4}SiO₃ |
| 0.1-3.00 | 0.1-3.00 | 0-1.00 | 0.1-2.00 | 0.03-2.00 | 0.03-2.00 | 0.1-5.00 |

In order to implement X8R temperature characteristics, dielectric compositions have conventionally been developed that contain a rare-earth material (such as Yb₂O₃) to raise the Curie temperature, or that employ a base material modified by substitution or the like, such as (Ba₁₋ₓCaₓ)TiO₃, instead of BaTiO₃, the base material major component. Here, in the case of the dielectric composition containing Yb₂O₃, a rare earth material, as the Curie temperature increases, the X8R standard that the temperature coefficient of capacitance (TCC) at 150° C. must change within the range of +15% to −15% can be satisfied. However, the dielectric composition containing Yb₂O₃ has a problem in that the sintering temperature increases as Yb₂O₃ is added in order to implement the X8R temperature characteristics. When the sintering temperature becomes excessively high, heat generation in the MLCC increases, which may cause damage to the Ni internal electrode, resulting in problems of connectivity of internal electrodes and complexity of the process. In addition, among the base materials modified by substitution or the like, a widely known one is (Ba₁₋ₓCaₓ)TiO₃, i.e. BCT, in which Ca is substituted for Ba. When such BCT is used alone or in a mixture in a dielectric composition, a change in capacitance according to temperature is reduced, while the Curie temperature increases, thereby satisfying the X8R standard requiring change within the range of +15% to −15%. However, the dielectric composition using BCT as a base material has the disadvantage of high difficulty in BCT synthesis. When synthesizing BCT, Ca initially substitutes for Ba, but as the amount of Ca added increases, it gradually substitutes Ti instead of Ba, resulting in Ba(Ti₁₋ₓCaₓ)O₃, and in this case, the Curie temperature is lowered, making it unsuitable for an X8R composition. In addition, BCT has a lower permittivity compared to the composition containing Yb₂O₃, which is somewhat disadvantageous in implementing capacitance.

In order to address this problem, dielectric compositions according to embodiments of the present disclosure are characterized by being able to suppress sintering temperature increases while meeting the X8R standard, which requires a change of 15% to −15%, by adding Yb₂O₃ and BaZrO₃ to BaTiO₃. In the dielectric compositions according to embodiments of the present disclosure, the addition of BaZrO₃ to BaTiO₃ reduces the amount of Yb₂O₃ added, thereby suppressing an increase in sintering temperature. Furthermore, BaZrO₃ reduces the overall permittivity while simultaneously reducing a change in permittivity according to temperature, thereby mitigating extreme permittivity changes around the Curie temperature. In other words, the dielectric compositions according to embodiments of the present disclosure satisfy the X8R (−55° C. to 150° C.) characteristics specified in the EIA standard, enabling the implementation of highly reliable dielectric compositions and multilayer ceramic capacitors including the same.

Hereinafter, each component of the dielectric compositions according to embodiments of the present disclosure will be described in more detail.

### Base Material Major Component

The dielectric compositions according to embodiments of the present disclosure may include a base material major component including Ba and Ti. According to embodiments, the base material major component is BaTiO₃.

The base material major component may be included in the dielectric composition in the form of a powder. The average particle diameter of the base material major component powder is not particularly limited, but may be 1000 nm or less. Preferably, the average particle diameter of the base material major component powder may be 200 nm to 350 nm, and more preferably, 250 nm.

### First Minor Component

The dielectric compositions according to embodiments of the present disclosure may include, as a first minor component, at least one selected from the group consisting of oxides and carbonates of Yb element. Alternatively, the first minor component may include at least one selected from the group consisting of oxides and carbonates of at least one of the other rare earth elements, Sc, Lu, and Tm, instead of the Yb element.

The first minor component may be included in an amount of 0.2 to 6 parts by mole per 100 parts by mole of the base material major component. The content of the first minor component may be based on the content of the element contained in the first minor component, regardless of the additive form, such as oxide or carbonate. For example, the total content of the elements contained in the first minor component may be 0.2 to 6 parts by mole per 100 parts by mole of the base material major component. For example, when the first minor component is Yb₂O₃, assuming that 2 parts by mole of Yb₂O₃ are present per 100 parts by mole of BaTiO₃, then 4 parts by mole of the metal Yb contained in the first minor component are present. Therefore, in this case, 4 parts by mole of Yb are contained per 100 parts by mole of BaTiO₃.

The first minor component can have the effect of shifting the Curie temperature toward a higher temperature and improving the stability of capacitance according to temperature changes. In other words, the first minor component serves to prevent a decrease in reliability of a multilayer ceramic capacitor formed of the dielectric compositions according to embodiments of the present disclosure.

When the content of Yb element included in the first minor component is less than 0.2 parts by mole per 100 parts by mole of the base material major component, the effect of improving the temperature coefficient of capacitance (TCC) at high temperatures may not be significant. When the content of Yb element included in the first minor component exceeds 6 parts by mole per 100 parts by mole of the base material major component, the characteristics related to firing may deteriorate.

### Second Minor Component

The dielectric compositions according to embodiments of the present disclosure may include, as a second minor component, at least one selected from the group consisting of oxides containing Ba and Zr. The second minor component is preferably BaZrO₃ or a mixture of BaO and ZrO₂, but is not limited thereto. In the case of BaZrO₃, the ratio of Ba and Zr is not particularly limited, and the molar ratio of Ba to Zr (Ba/Zr) may be 0.5 to 1.5, and preferably 0.9 to 1.1.

When the second minor component is added, the overall permittivity may decrease, and a change in permittivity according to temperature may be flattened. The second minor component may be included in an amount of 0.1 to 3 parts by mole per 100 parts by mole of the base material major component. When the content of the second minor component is less than 0.1 parts by mole per 100 parts by mole of the base material major component, the effect of improving the TCC at high temperatures may not be significant. When the content of the second minor component exceeds 3 parts by mole per 100 parts by mole of the base material major component, the high-temperature withstand voltage characteristics may deteriorate.

### Third Minor Component

The dielectric compositions according to embodiments of the present disclosure may include, as a third minor component, at least one selected from the group consisting of oxides and carbonates of Y element. Alternatively, the third minor component may include at least one selected from the group consisting of oxides and carbonates of at least one of the other rare earth elements, Dy, Ho, Tb, Gd, Eu, and Er, instead of the Y element. The third minor component is preferably Y₂O₃, an oxide of Y, but is not limited thereto.

The third minor component may be included in an amount of 2 parts or less by mole per 100 parts by mole of the base material major component. The content of the third minor component may be based on the content of the element contained in the third minor component, regardless of the additive form, such as oxide or carbonate. For example, the total content of the elements contained in the third minor component may be 2 parts or less by mole per 100 parts by mole of the base material major component. For example, when the third minor component is Y₂O₃, assuming that 0.3 parts by mole of Y₂O₃ are present per 100 parts by mole of BaTiO₃, then 0.6 parts by mole of the metal Y contained in the third minor component are present. Therefore, in this case, 0.6 parts by mole of Y are contained per 100 parts by mole of BaTiO₃.

The third minor component can help improve the TCC at high temperatures and serve to prevent a decrease in reliability of a multilayer ceramic capacitor formed of the dielectric composition. If the content of Y element included in the third minor component exceeds 2 parts by mole per 100 parts by mole of the base material major component, this effect may be insufficient.

### Fourth Minor Component

The dielectric compositions according to embodiments of the present disclosure may include, as a fourth minor component, at least one of oxides and carbonates of a fixed-valence acceptor element including Mg.

The fourth minor component may be included in an amount of 0.1 to 2 parts by mole per 100 parts by mole of the base material major component. The content of the fourth minor component may be based on the content of the Mg element contained in the fourth minor component, regardless of the additive form, such as oxide or carbonate. For example, the content of the Mg element contained in the fourth minor component may be 0.1 to 2 parts by mole per 100 parts by mole of the base material major component.

When the content of the fourth minor component is less than 0.1 parts by mole or more than 2 parts by mole per 100 parts by mole of the dielectric base material major component, the permittivity and the high-temperature withstand voltage characteristics may be degraded, which is undesirable.

### Fifth Minor Component

The dielectric compositions according to embodiments of the present disclosure may include, as a fifth minor component, at least one selected from the group consisting of oxides and carbonates of variable-valence acceptor elements including one or more of V, Mn, Cr, Fe, Ni, Co, Cu, and Zn. The fifth minor component is preferably at least one selected from the group consisting of V₂O₅ and MnO₂, but is not limited thereto.

The fifth minor component may be included in an amount of 0.03 to 4 parts by mole per 100 parts by mole of the base material major component. The content of the fifth minor component may be based on the content of the element contained in the fifth minor component, regardless of the additive form, such as oxide or carbonate. For example, the total content of the elements contained in the fifth minor component may be 0.03 to 4 parts by mole per 100 parts by mole of the base material major component.

The fifth minor component can improve the reduction resistance of the dielectric composition, thereby enhancing the high-temperature withstand voltage characteristics. When the content of the fifth minor component is less than 0.03 parts by mole, the high-temperature withstand voltage may be reduced, and when it exceeds 4 parts by mole, the reliability of the dielectric composition may deteriorate (for example, a decrease in permittivity).

### Sixth Minor Component

The dielectric compositions according to embodiments of the present disclosure may include, as a sixth minor component, at least one selected from the group consisting of oxides of Si element, carbonates of Si element, and glass containing Si element. Preferably, the sixth minor component may include a composite oxide represented by BaₓCa₁₋ₓSiO₃ (wherein x is 0.3 to 0.8). The x value of the composite oxide may be 0.3 to 0.8. When the x value is too small, the dielectric properties may deteriorate due to a reaction between SiO₂ and the major component, BaTiO₃. Conversely, when the x value is too large, the melting point may increase, deteriorating the properties related to firing.

The sixth minor component may be included in an amount of 0.1 to 5 parts by mole per 100 parts by mole of the base material major component. When the content of the sixth minor component is less than 0.1 part by mole, the rate of change in capacitance according to temperature may increase. On the other hand, when the content of the sixth minor component exceeds 5 parts by mole, problems such as reduced sinterability and density, and formation of secondary phases may occur, which is undesirable.

Hereinafter, the configuration and effects of the present disclosure will be described in more detail by way of specific examples and comparative examples. However, these examples are merely intended to more clearly understand the present disclosure and are not intended to limit the scope of the present disclosure.

As starting materials for forming the dielectric layer, a powder of the major component BaTiO₃ was prepared, and Yb₂O₃, BaZrO₃, Y₂O₃, MgCO₃, V₂O₅, MnO₂, and Ba_{0.6}Ca_{0.4}SiO₃ were respectively prepared as minor components. Here, a BaTiO₃ mixed solid-solution powder, which is the base material powder containing the major component, was prepared by a solid-state method as follows.

The starting raw materials are BaCO₃ and TiO₂. These starting raw material powders were mixed by ball milling and then calcined at 900 to 1000° C. to prepare the major component base material powder. The major component base material powder was mixed with the minor component additive powder in the component ratio shown in Table 2, and then the raw material powders containing the major component and minor component were ball milled for a predetermined period of time (e.g., 20 hours) by using zirconia balls as a mixing/dispersing medium and mixing ethanol/toluene with a dispersant and binder.

The resulting slurry was used to prepare a green sheet having a thickness of 10 μm using a doctor-blade coater, and a Ni internal electrode was printed on the green sheet. The upper and lower covers were fabricated by stacking 25 layers of cover sheets, and 21 layers of printed active sheets were stacked under pressure to fabricate a pressed bar. The pressed bar was cut into chips of size 3225 (3.2 mm length×2.5 mm width×2.5 mm thickness) using a cutter.

After the fabricated chips were calcined, they were fired at a temperature of 1150° C. to 1350° C. in a reducing atmosphere (0.1% H₂/99.9% N₂, H₂O/H₂/N₂ atmosphere) for 1 hour or more, and then heat-treated by reoxidation at a temperature of 1000° C. in a nitrogen (N₂) atmosphere for 2 hours or more.

The fired chips were subjected to a termination process and electrode firing using a copper paste to complete an external electrode.

For the multilayer ceramic capacitor specimen completed as described above, capacitance (permittivity), temperature coefficient of capacitance (TCC), sintering temperature, and the like were measured and evaluated. Furthermore, room temperature insulation resistance, high-temperature accelerated life, loss factor, etc. were evaluated, but are not described.

Room temperature capacitance was measured using an LCR meter at 1 kHz and AC 0.2 V/μm. The permittivity of the multilayer ceramic capacitor (MLCC) chips was calculated from the capacitance, the dielectric thickness of the multilayer ceramic capacitor (MLCC) chip, the internal electrode area, and the number of stacks.

The temperature coefficient of capacitance was measured in a temperature range of −55° C. to 150° C. In this temperature range, the capacitance change was measured using an LCR meter at 1 KHz and 1 Vrms. At this time, the temperature coefficient of capacitance (%) at each temperature is measured compared to the capacitance at 25° C. In the present specification, the temperature coefficient of capacitance at 150° C. is described. When the temperature coefficient of capacitance (TCC) at 150° C. was within ±15%, it was judged as good, and otherwise, it was judged as bad.

Table 2 below shows the composition of comparative examples, and Table 3 shows the characteristics of the multilayer ceramic capacitor chips corresponding to the compositions specified in Table 2. Comparative Examples 1 to 4 in Table 2 are different from the examples described below in that BaZrO₃, which is the second minor component, was not added.

TABLE 2

| | Number of moles of minor components per 100 moles of the | | | | | | |
|---|---|---|---|---|---|---|---|
| | base material major component | | | | | | |
| | First | Second | Third | Fourth | | | Sixth |
| | minor | minor | minor | minor | Fifth minor | | minor |
| | component | component | component | component | component | | component |
| | Yb₂O₃ | BaZrO₃ | Y₂O₃ | MgCO₃ | V₂O₅ | MnO₂ | Ba_{0.6}Ca_{0.4}SiO₃ |
| Comparative | 1.09 | 0 | 0 | 1.45 | 0.06 | 0.13 | 2.7 |
| Example 1 | | | | | | | |
| Comparative | 2.18 | 0 | 0 | 1.45 | 0.06 | 0.13 | 2.7 |
| Example 2 | | | | | | | |
| Comparative | 4.36 | 0 | 0 | 1.45 | 0.06 | 0.13 | 2.7 |
| Example 3 | | | | | | | |
| Comparative | 5 | 0 | 0 | 1.45 | 0.06 | 0.13 | 2.7 |
| Example 4 | | | | | | | |

TABLE 3

| | | High- | | |
|---|---|---|---|---|
| | | temperature | Sintering | |
| | | TCC | temperature | Judgment of |
| | Permittivity | (150° C.) | (° C.) | characteristics |
| Comparative | 1800 | −19.8 | 1180 | X |
| Example 1 | | | | |
| Comparative | 1500 | −19.4 | 1200 | X |
| Example 2 | | | | |
| Comparative | 1350 | −13.0 | 1290 | ◯ |
| Example 3 | | | | |
| Comparative | 1350 | −10.1 | 1310 | ◯ |
| Example 4 | | | | |

Comparative Examples 1 to 4 in Table 2 represent samples in which the content of the first minor component Yb was changed while the content of the third minor component Y was fixed at 0 mol, the content of the fourth minor component Mg was fixed at 1.45 mol, the content of the sum of the fifth minor components (V, Mn) was fixed at 0.25 mol, the content of the sixth minor component was fixed at 2.7 mol, and no second minor component was added. Table 3 shows the characteristics of samples corresponding to Comparative Examples 1 to 4 in Table 2. In the range where the content of the first minor component Yb was 4.36 mol or less (Comparative Examples 1 to 2), the high-temperature TCC (150° C.) exceeded ±15%, resulting in vulnerability to temperature changes. In the range where the content of the first minor component Yb was 8.72 mol or more (Comparative Examples 3 to 4), the high-temperature TCC satisfied the X8R standard within ±15%. However, as the content of Yb increases, the temperature coefficient of capacitance decreases, but there is a problem in that the sintering temperature increases and thus the Ni internal electrode is damaged. According to the comparative examples of the present disclosure, when the content of the first minor component Yb is 10 mol or more, it can be said that a firing temperature of 1300° C. or higher is required.

In order to address this problem, dielectric compositions according to embodiments of the present disclosure are characterized by being able to suppress sintering temperature increases while meeting the X8R standard, which requires a change within a range of 15% to −15%, by adding Yb₂O₃ and BaZrO₃ to BaTiO₃.

Table 4 below shows the composition of the examples, and Table 5 shows the characteristics of the multilayer ceramic capacitor chips corresponding to the compositions specified in Table 4. Examples 2 to 6 in Table 4 differ from the comparative examples described above in that BaZrO₃, which is the second minor component, was added.

TABLE 4

| | Number of moles of minor components per 100 moles of the | | | | | | |
|---|---|---|---|---|---|---|---|
| | base material major component | | | | | | |
| | First | Second | Third | Fourth | | | Sixth |
| | minor | minor | minor | minor | Fifth minor | | minor |
| | component | component | component | component | component | | component |
| | Yb₂O₃ | BaZrO₃ | Y₂O₃ | MgCO₃ | V₂O₅ | MnO₂ | Ba_{0.6}Ca_{0.4}SiO₃ |
| Example 1 | 2 | 0 | 0 | 1.45 | 0.06 | 0.13 | 2.7 |
| Example 2 | 2 | 1 | 0 | 1.45 | 0.06 | 0.13 | 2.7 |
| Example 3 | 2 | 1.5 | 0 | 1.45 | 0.06 | 0.13 | 2.7 |
| Example 4 | 2 | 2 | 0 | 1.45 | 0.06 | 0.13 | 2.7 |
| Example 5 | 2 | 3 | 0 | 1.45 | 0.06 | 0.13 | 2.7 |
| Example 6 | 2 | 5 | 0 | 1.45 | 0.06 | 0.13 | 2.7 |

TABLE 5

| | | High- | | |
|---|---|---|---|---|
| | | temperature | Sintering | |
| | | TCC | temperature | Judgment of |
| | Permittivity | (150° C.) | (° C.) | characteristics |
| Example 1 | 1500 | −16.5 | 1200 | X |
| Example 2 | 1900 | −11.3 | 1265 | ◯ |
| Example 3 | 1800 | −11.1 | 1250 | ◯ |
| Example 4 | 1800 | −12.3 | 1250 | ◯ |
| Example 5 | 1900 | −12.8 | 1245 | ◯ |
| Example 6 | 1900 | −19.7 | 1235 | X |

Examples 1 to 6 in Table 4 represent samples in which the content of the second minor component was changed while the content of the first minor component Yb was fixed at 2 mol, the content of the third minor component Y was fixed at 0 mol, the content of the fourth minor component Mg was fixed at 1.45 mol, the content of the sum of the fifth minor components (V, Mn) was fixed at 0.25 mol, and the content of the sixth minor component was fixed at 2.7 mol. Table 5 shows the characteristics of samples corresponding to Examples 1 to 6 in Table 4. When the content of the second minor component was 0 mol (Example 1), there was a problem in that the high-temperature TCC (150° C.) exceeded ±15%, resulting in vulnerability to temperature changes. In addition, when the content of the second minor component exceeded 3 mol (Example 6), there was also a problem in that the high-temperature TCC (150° C.) exceeded ±15%, resulting in vulnerability to temperature changes. In the range where the content of the second minor component is in the range of more than 0 mol (e.g., 0.1 mol or more) and 3 mol or less (Examples 2 to 5), the high-temperature TCC was found to be within ±15%, satisfying the X8R standard. Therefore, the appropriate content range of the second minor component can be said to be 0.1 to 3 parts by mole per 100 parts by mole of the base material major component.

In Examples 2 to 5, as BaZrO₃ as the second minor component was added, the high-temperature TCC was found to be within ±15%, satisfying the X8R standard, while the sintering temperature was in the range of 1245° C. to 1265° C. That is, the sintering temperatures of Examples 2 to 5 were found to be lower than those of Comparative Examples 3 and 4 described above, which were in the range of 1290° C. to 1310° C. As described above, it can be seen that BaZrO₃ as the second minor component is added to the dielectric composition, the standard of X8R can be satisfied even without increasing the content of Yb₂O₃ as the first minor component, and further, there is an effect of suppressing the increase in sintering temperature because the content of Yb₂O₃ can be lowered.

TABLE 6

| | Number of moles of minor components per 100 moles of the | | | | | | |
|---|---|---|---|---|---|---|---|
| | base material major component | | | | | | |
| | First | Second | Third | Fourth | | | Sixth |
| | minor | minor | minor | minor | Fifth minor | | minor |
| | component | component | component | component | component | | component |
| | Yb₂O₃ | BaZrO₃ | Y₂O₃ | MgCO₃ | V₂O₅ | MnO₂ | Ba_{0.6}Ca_{0.4}SiO₃ |
| Example 7 | 0 | 1.5 | 0 | 1.45 | 0.06 | 0.13 | 2.7 |
| Example 8 | 0.1 | 1.5 | 0 | 1.45 | 0.06 | 0.13 | 2.7 |
| Example 9 | 2 | 1.5 | 0 | 1.45 | 0.06 | 0.13 | 2.7 |
| Example 10 | 3 | 1.5 | 0 | 1.45 | 0.06 | 0.13 | 2.7 |
| Example 11 | 4 | 1.5 | 0 | 1.45 | 0.06 | 0.13 | 2.7 |

TABLE 7

| | | High- | | |
|---|---|---|---|---|
| | | temperature | Sintering | |
| | | TCC | temperature | Judgment of |
| | Permittivity | (150° C.) | (° C.) | characteristics |
| Example 7 | 1900 | −19.4 | 1200 | X |
| Example 8 | 1800 | −11.5 | 1245 | ◯ |
| Example 9 | 1500 | −10.9 | 1250 | ◯ |
| Example 10 | 1400 | −12.3 | 1265 | ◯ |
| Example 11 | 1350 | −19.8 | 1280 | X |

Examples 7 to 11 in Table 6 represent samples in which the content of the first minor component was changed while the content of the second minor component was fixed at 1.5 mol, the content of the third minor component Y was fixed at 0 mol, the content of the fourth minor component Mg was fixed at 1.45 mol, the content of the sum of the fifth minor components (V, Mn) was fixed at 0.25 mol, and the content of the sixth minor component was fixed at 2.7 mol. Table 7 shows the characteristics of samples corresponding to Examples 7 to 11 in Table 6. When the content of the first minor component Yb was 0 mol (Example 7), there was a problem in that the high-temperature TCC (150° C.) exceeded ±15%, resulting in vulnerability to temperature changes. In addition, when the content of the first minor component Yb exceeded 6 mol (Example 11), there was also a problem in that the high-temperature TCC (150° C.) exceeded ±15%, resulting in vulnerability to temperature changes. In the range where the content of the first minor component Yb is in the range of more than 0 mol (e.g., 0.2 mol or more) and 6 mol or less (Examples 8 to 10), the high-temperature TCC was found to be within ±15%, satisfying the X8R standard, and the sintering temperature was also found to be lower than that of the comparative examples. Therefore, the appropriate content range of the first minor component Yb can be said to be 0.2 to 6 parts by mole per 100 parts by mole of the base material major component in terms of an element ratio.

TABLE 8

| | Number of moles of minor components per 100 moles of the | | | | | | |
|---|---|---|---|---|---|---|---|
| | base material major component | | | | | | |
| | First | Second | Third | Fourth | | | Sixth |
| | minor | minor | minor | minor | Fifth minor | | minor |
| | component | component | component | component | component | | component |
| | Yb₂O₃ | BaZrO₃ | Y₂O₃ | MgCO₃ | V₂O₅ | MnO₂ | Ba_{0.6}Ca_{0.4}SiO₃ |
| Example 12 | 2 | 1.5 | 0.5 | 1.45 | 0.06 | 0.13 | 2.7 |
| Example 13 | 2 | 1.5 | 1 | 1.45 | 0.06 | 0.13 | 2.7 |
| Example 14 | 2 | 1.5 | 2 | 1.45 | 0.06 | 0.13 | 2.7 |

TABLE 9

| | | High- | | |
|---|---|---|---|---|
| | | temperature | Sintering | |
| | | TCC | temperature | Judgment of |
| | Permittivity | (150° C.) | (° C.) | characteristics |
| Example 12 | 1800 | −11.0 | 1245 | ◯ |
| Example 13 | 1800 | −10.9 | 1250 | ◯ |
| Example 14 | 1500 | −19.1 | 1300 | X |

Examples 12 to 14 in Table 8 represent samples in which the content of the third minor component Y was changed while the content of the first minor component Yb was fixed at 2 mol, the content of the second minor component was fixed at 1.5 mol, the content of the fourth minor component Mg was fixed at 1.45 mol, the content of the sum of the fifth minor components (V, Mn) was fixed at 0.25 mol, and the content of the sixth minor component was fixed at 2.7 mol. Table 9 shows the characteristics of samples corresponding to Examples 12 to 14 in Table 8. When the content of the third minor component Y exceeded 2 mol (Example 14), there was a problem in that the high-temperature TCC (150° C.) exceeded ±15%, resulting in vulnerability to temperature changes. In the range where the content of the third minor component Y was in the range of 2 mol or less (Examples 12 to 13), the high-temperature TCC was found to be within ±15%, satisfying the X8R standard, and the sintering temperature was also found to be relatively low. Therefore, the appropriate content range of the third minor component Y can be said to be 2 parts or less by mole per 100 parts by mole of the base material major component in terms of an element ratio.

The present disclosure is not limited by the above-described embodiments and the attached drawings, but is limited by the appended claims. Therefore, it will be apparent to those skilled in the art that various forms of substitutions, modifications, and alterations are possible without departing from the technical spirit of the present disclosure as defined in the claims, and such forms also fall within the technical spirit defined in the appended claims.

1. A dielectric composition comprising a barium titanate-based base material major component and a minor component,
wherein the minor component comprises at least one minor component of:
a first minor component including at least one selected from the group consisting of oxides and carbonates of Yb element;
a second minor component including at least one selected from the group consisting of oxides containing Ba and Zr;
a third minor component including at least one selected from the group consisting of oxides and carbonates of Y element;
a fourth minor component including at least one selected from the group consisting of oxides and carbonates of a fixed-valence acceptor element including Mg;
a fifth minor component including at least one selected from the group consisting of oxides and carbonates of a variable-valence acceptor element including at least one of V, Mn, Cr, Fe, Ni, Co, Cu, and Zn; and
a sixth minor component including at least one selected from the group consisting of oxides, carbonates, and glasses of Si element,
wherein the at least one minor component comprises the first minor component, and
the content of the Yb element contained in the first minor component is 0.2 to 6 parts by mole per 100 parts by mole of the base material major component.

2. The dielectric composition of claim 1, wherein the at least one minor component further comprises the second minor component, and
the content of the second minor component is 0.1 to 3 parts by mole per 100 parts by mole of the base material major component.

3. The dielectric composition of claim 1, wherein the at least one minor component further comprises the third minor component, and
the content of the Y element contained in the third minor component is 2 parts or less by mole per 100 parts by mole of the base material major component.

4. The dielectric composition of claim 1, wherein the at least one minor component further comprises the fourth minor component, and
the content of the Mg element contained in the fourth minor component is 0.1 to 2 parts by mole per 100 parts by mole of the base material major component.

5. The dielectric composition of claim 1, wherein the at least one minor component further comprises the fifth minor component, and
the content of the variable-valence acceptor element contained in the fifth minor component is 0.03 to 4 parts by mole per 100 parts by mole of the base material major component.

6. The dielectric composition of claim 1, wherein the at least one minor component further comprises the sixth minor component, and
the content of the sixth minor component is 0.1 to 5 parts by mole per 100 parts by mole of the base material major component.

7. The dielectric composition of claim 6, wherein the sixth minor component comprises a composite oxide represented by BaₓCa₁₋ₓSiO₃, wherein x is 0.3 to 0.8.

8. A method for manufacturing a dielectric composition, the method comprising:
preparing a barium titanate-based base material major component;
preparing at least one minor component of: a first minor component including at least one selected from the group consisting of oxides and carbonates of Yb element, a second minor component including at least one selected from the group consisting of oxides containing Ba and Zr, a third minor component including at least one selected from the group consisting of oxides and carbonates of Y element, a fourth minor component including at least one selected from the group consisting of oxides and carbonates of a fixed-valence acceptor element including Mg, a fifth minor component including at least one selected from the group consisting of oxides and carbonates of a variable-valence acceptor element including at least one of V, Mn, Cr, Fe, Ni, Co, Cu, and Zn, and a sixth minor component including at least one selected from the group consisting of oxides, carbonates, and glasses of Si element, wherein the at least one minor component comprises the first minor component;
preparing a mixture including the base material major component and the at least one minor component; and
firing the mixture,
wherein the content of the Yb element contained in the first minor component is 0.2 to 6 parts by mole per 100 parts by mole of the base material major component.

9. The method of claim 8, wherein the sintering temperature of the mixture is 1150° C. or higher.
